(19) United States
(12) Patent Application Publication
(10) Pub. No.: US 2024/0233696 A1
(43) Pub. Date: Jul. 11, 2024

(54) CONCURRENT SONIFICATION OF MULTIPLE DATA STREAMS

(71) Applicant: CollegeNet, Inc., Portland, OR (US)

(72) Inventors: James H. Wolfston, JR., West Linn, OR (US); Jeff M. Bolton, Portland, OR (US)

(21) Appl. No.: 18/153,308

(22) Filed: Jan. 11, 2023

(51) Int. Cl. G10H 1/08; G10H 1/00

(52) U.S. Cl. CPC G10H 1/08; G10H 1/0025

(57) ABSTRACT

In some embodiments, a computer-implemented method of arranging and presenting a concurrent sonic representation of multiple data sets is provided. For each data set of a plurality of data sets, a threshold for compliance for the data set is determined, and a first set of musical tones and a second set of musical tones for the data set are selected. The first set of musical tones sounds harmonious and represents compliance to the threshold and wherein the second set of musical tones sounds discordant and represents non-compliance to the threshold. Concurrent presentation of musical tones for multiple data sets sounds harmonious when a combined threshold is met by the multiple data sets and sounds discordant when the combined threshold is not met by the multiple data sets.

### BACKGROUND

The use of smart speakers, smart watches, and other similar computing devices is becoming more and more prevalent. The ubiquity and constant availability of such computing devices make them particularly useful for data monitoring applications. However, such computing devices typically have limited or no visual display capabilities, even if they have a loudspeaker or other auditory presentation capability. This lack of visual display capability makes it difficult to efficiently review or monitor complex data sets using these types of computing devices. What is desired are techniques that make it possible to efficiently monitor complex data sets using computing devices with limited or no visual display capability.

### SUMMARY

This summary is provided to introduce a selection of concepts in a simplified form that are further described below in the Detailed Description. This summary is not intended to identify musical key features of the claimed subject matter, nor is it intended to be used as an aid in determining the scope of the claimed subject matter.

In some embodiments, a method of concurrent sonic presentation of multiple data sets is provided. A determination is made regarding whether a first data set complies with a first separate threshold. A determination is made regarding whether a second data set complies with a second separate threshold. A determination is made regarding whether the first data set and the second data set comply with a combined threshold. A first musical key is selected for representation of the first data set and a second musical key selected for representation of the second data set based on at least the determinations of whether the first data set complies with the first separate threshold, whether the second data set complies with the second separate threshold, and whether the first data set and the second data set comply with the combined threshold. Tones are presented in the first musical key and the second musical key, wherein the tones are harmonious or discordant based on whether the first data set and the second data set comply with the combined threshold.

In some embodiments, a computing system including a loudspeaker, a processor, and a non-transitory computer-readable medium is provided. The computer-readable medium has computer-executable instructions stored thereon that, in response to execution by the processor, cause the computing system to perform actions for concurrent sonic presentation of multiple data sets. The actions comprise: determining whether a first data set complies with a first separate threshold; determining whether a second data set complies with a second separate threshold; determining whether the first data set and the second data set comply with a combined threshold; selecting a first musical key for representation of the first data set and a second musical key for representation of the second data set based on at least the determinations of whether the first data set complies with the first separate threshold, whether the second data set complies with the second separate threshold, and whether the first data set and the second data set comply with the combined threshold; and presenting, using the loudspeaker, tones in the first musical key and the second musical key, wherein the tones are harmonious or discordant based on whether the first data set and the second data set comply with the combined threshold.

In some embodiments, a non-transitory computer-readable medium having computer-executable instructions stored thereon is provided. The instructions, in response to execution by one or more processors of a computing device, cause the computing device to perform actions for concurrent sonic presentation of multiple data sets, the actions comprising: determining whether a first data set complies with a first separate threshold; determining whether a second data set complies with a second separate threshold; determining whether the first data set and the second data set comply with a combined threshold; selecting a first musical key for representation of the first data set and a second musical key for representation of the second data set based on at least the determinations of whether the first data set complies with the first separate threshold, whether the second data set complies with the second separate threshold, and whether the first data set and the second data set comply with the combined threshold; and presenting tones in the first musical key and the second musical key, wherein the tones are harmonious or discordant based on whether the first data set and the second data set comply with the combined threshold.

In some embodiments, a computer-implemented method of arranging and presenting a concurrent sonic representation of multiple data sets is provided. For each data set of a plurality of data sets, a threshold for compliance for the data set is determined, and a first set of musical tones and a second set of musical tones for the data set are selected. The first set of musical tones sounds harmonious and represents compliance to the threshold and wherein the second set of musical tones sounds discordant and represents non-compliance to the threshold. Concurrent presentation of musical tones for multiple data sets sounds harmonious when a combined threshold is met by the multiple data sets and sounds discordant when the combined threshold is not met by the multiple data sets.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic drawing that illustrates a non-limiting example embodiment of a system for generating combined presentations of data streams according to various aspects of the present disclosure.

FIG. 2A-FIG. 2C illustrate examples of different types of sonic presentations that may be generated by the system 100 according to various aspects of the present disclosure.

FIG. 3A and FIG. 3B illustrate non-limiting examples of sonic presentations that may be generated by comparing multiple data sets to both separate thresholds and a combined threshold according to various aspects of the present disclosure.

FIG. 4 is a block diagram that illustrates aspects of a non-limiting example embodiment of a sonification computing system according to various aspects of the present disclosure.

FIG. 5 is a flowchart that illustrates a non-limiting example embodiment of a method of concurrent sonic presentation of multiple data sets according to various aspects of the present disclosure.

### DETAILED DESCRIPTION

In some embodiments of the present disclosure, techniques are provided that allow for concurrent presentation of multiple data streams, even on devices with limited or no visual display capabilities. The techniques disclosed herein include concurrent sonification of the multiple data streams such that the resulting sonification represents whether the data streams meet or fail to meet separate thresholds and/or combined thresholds. By using these techniques to present the sonification via a loudspeaker on any type of device (including but not limited to smartphones, Bluetooth speakers/headphones, and other types of devices with limited display capabilities), the user-interface limitations of such hardware can be overcome to allow users to efficiently review the data streams for compliance with the thresholds. In addition to overcoming user-interface limitations of particular hardware, embodiments of the present disclosure also improve accessibility (i.e., provides improved access to information for those who are visually impaired), and provide a very useful way in which professionals who must concentrate on using their eyes during their work (e.g., pilots, drivers, etc.) would be able to use the sonic presentation to monitor data sets such as instrument readings without taking their eyes off of their primary task.

Generally, data sets that comply with thresholds are represented by sonification in harmonious musical keys, while data sets that fail to comply with thresholds are represented by sonification in discordant musical keys. “Harmonious musical keys” are groups of tones or notes which are generally considered in accepted musical theory to be pleasing to the human ear when played together or in sequence, while “discordant musical keys” are musical keys which are generally considered in accepted musical theory to be unpleasant or harsh to the human ear when played together or in sequence. Some non-limiting examples of tones in a harmonious musical key include unisons, octaves, perfect fourths, perfect fifths, and major thirds. Some non-limiting example of tones in a discordant musical key include tritones, minor seconds, and major sevenths.

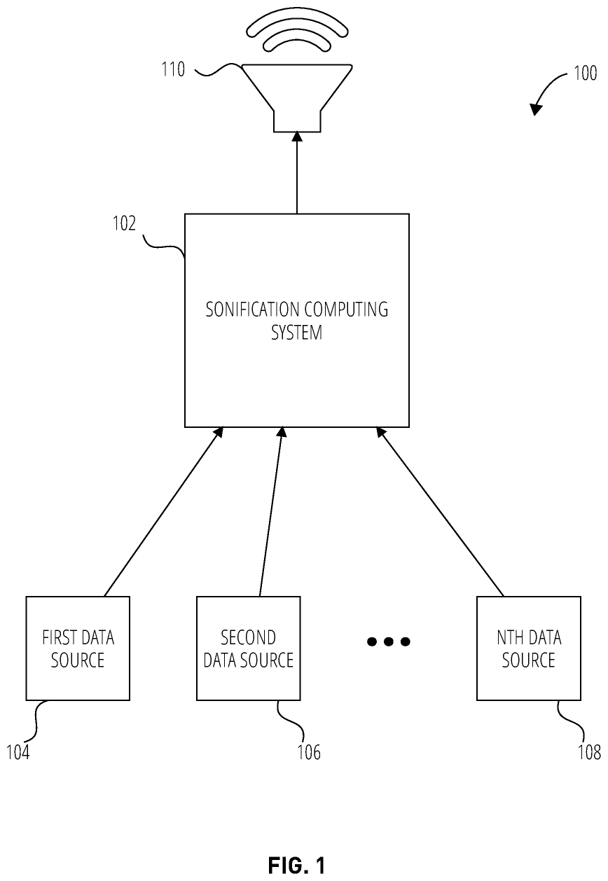

FIG. 1 is a schematic drawing that illustrates a non-limiting example embodiment of a system for generating combined presentations of data streams according to various aspects of the present disclosure.

As shown, the system 100 includes a plurality of data sources, including first data source 104, second data source 106, and nth data source 108. Each data source includes one or more computing devices having one or more sensors that generate data sets, and each data source is configured to transmit the data sets to the sonification computing system 102 using any suitable technique, including but not limited to wired and/or wireless communication techniques and the exchange of removable computer-readable media (e.g., USB drives, etc.). The sonification computing system 102 is then configured to generate a sonic presentation via a loudspeaker 110 that represents comparisons of the data sets to various thresholds.

Though three data sources are illustrated in the system 100, one will recognize that in some embodiments, either more or fewer data sources may be present. In some embodiments, each data source may be associated with a single data set. In some embodiments, a single data source may be associated with more than one data set. In some embodiments, data generated by multiple data sources may be combined into a single data set.

The data sets generated by the data sources may be any type of information that can be compared to thresholds, though the system 100 is particularly useful for generating presentations where many data sources are to be concurrently monitored. One non-limiting example of a type of information to be included in a data set is building occupancy information. A measurement of building occupancy (a number of people inside a room or a building) can be generated by an occupancy sensor of a data source, and the measurements can be provided by the data source as a data set. In fact, this type of information is particularly appropriate for use with embodiments of the present disclosure. Building occupancy information is often monitored both separately and in combination, such as individual room occupancy numbers being below separate thresholds as well as a total building occupancy number being below a combined threshold; or individual building occupancy numbers being below separate thresholds as well as a total campus occupancy number being below a combined threshold.

Though building occupancy measurements are a particularly apt example, it should not be seen as limiting. In some embodiments, other types of information may be used, including but not limited to environmental conditions (e.g., temperature, humidity, UV exposure, precipitation amounts, etc.), performance of mechanical devices (e.g., number of units produced, rate of production, status reported by device sensors, errors, etc.), and any other type of information to be monitored.

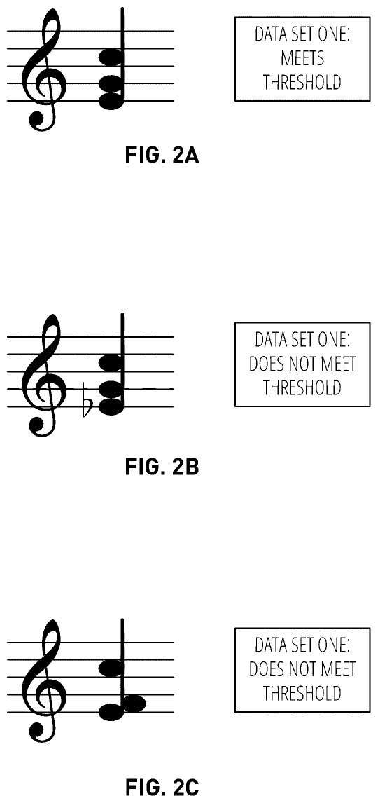

FIG. 2A-FIG. 2C illustrate examples of different types of sonic presentations that may be generated by the system 100 according to various aspects of the present disclosure. The illustrated sonic presentations are the result of a comparison of a first data set (“data set one”) to a threshold. For each sonic presentation, tones are selected based on whether the first data set meets the threshold.

FIG. 2A is a non-limiting example of a sonic presentation generated when the first data set meets the threshold. The tones selected in FIG. 2A are harmonious tones to reflect that the first data set meets the threshold. The tones selected are tones from the tonic chord in the musical key of C major (specifically, the first inversion of the C-major triad, E-G-C). Major chords are typically perceived as harmonious and bright, and so presentation of these tones would be readily recognizable as an indication that the threshold was met.

FIG. 2B is a non-limiting example of a sonic presentation generated when the first data set does not meet the threshold. The tones selected in FIG. 2B are also harmonious tones, but are in a different musical key than the tones illustrated in FIG. 2B to reflect that the first data set does not meet the threshold. The tones selected are tones from the tonic chord in the musical key of C minor (specifically, the first inversion of the C-minor triad, E♭-G-C). Minor chords are typically perceived as harmonious but dark, and so the darkness of the presentation of these tones would be readily recognizable as an indication that the threshold was not met.

FIG. 2C is another non-limiting example of a sonic presentation generated when the first data set does not meet the threshold. The tones selected in FIG. 2C are discordant: by changing the G of the C major chord to an F to make the chord E-F-C, the half-step interval between the E and the F tones becomes discordant and is typically perceived as a displeasing sound. Since this presentation would be displeasing, it would be readily recognizable as an indication that the threshold was not met.

The presentations illustrated in FIG. 2A-FIG. 2C show the comparison of a single data set to a single threshold. While this can be useful in easily generating presentations for a single data set using computing devices with limited visual display capabilities, some embodiments of the present disclosure provide even more power by concurrently presenting tones for multiple data sets to demonstrate whether both separate thresholds and combined thresholds are met.

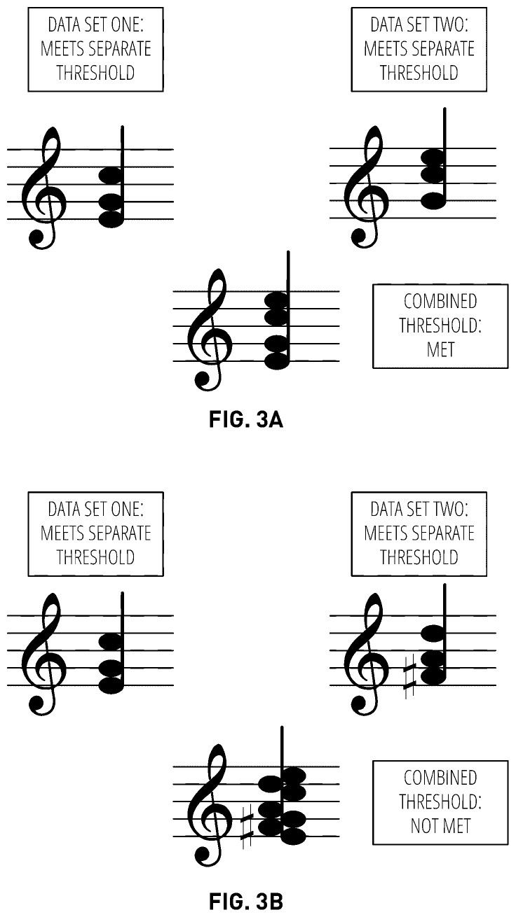

FIG. 3A and FIG. 3B illustrate non-limiting examples of sonic presentations that may be generated by comparing multiple data sets to both separate thresholds and a combined threshold according to various aspects of the present disclosure. Based on these sonic presentations, it can easily be determined by a user whether the first data set and the second data set comply with both their separate thresholds and a combined threshold, even when presented by computing devices with limited or no visual display capabilities.

In FIG. 3A, a sonic presentation is illustrated wherein a first data set meets a first threshold, a second data set meets a second threshold, and the combination of the first data set and the second data set also meets a combined threshold. The illustrated tones for the first data set are the same as the illustrated tones for FIG. 2A, selected from the musical key of C major (the first inversion of the C-major triad, E-G-C), to indicate that the first data set meets its separate threshold by presenting tones in a harmonious musical key.

The illustrated tones for the second data set are chosen to indicate that the second data set also meets its separate threshold. As such, the illustrated tones for the second data set are also in a harmonious musical key. Further, because the first data set and the second data set meet a combined threshold, the musical key selected for the second data set is not just a harmonious musical key, but it is also a mutually harmonious musical key along with the first musical key (that is, the first musical key and the second musical key are harmonious with each other).

Accordingly, as illustrated, the tones for the second data set are also selected from the tonic chord of the musical key of C major (specifically, the second inversion of the C-major triad, G-C-E). When played concurrently, a tetrad based on the tonic chord of C major (specifically, the first inversion of a c-major tetrad, E-G-C-E) is formed, which itself is a harmonious chord and should sound pleasing.

Though the second musical key was illustrated in FIG. 3A as being from the same chord as the first musical key to ensure that they are mutually harmonious (i.e., both were based on the tonic chord of C major), this is an example only and should not be seen as limiting. In some embodiments, the first musical key and the second musical key may be from different chords that are nevertheless mutually harmonious by virtue of not containing any relative half-step intervals.

If the second data set had not met its threshold, then a discordant musical key may have been chosen for the second musical key, and the tones selected for the second data set would sound discordant whether played separately or along with the tones selected for the first data set. By listening to those tones, it would be clear to the listener from the discordance that at least one threshold was not being met.

A more complex situation occurs when the first data set meets its separate threshold and the second data set also meets its separate threshold, yet the two data sets combined fail to meet the combined threshold. Accordingly, in FIG. 3B, a sonic presentation is illustrated wherein a first data set meets a first threshold, a second data set meets a second threshold, but the combination of the first data set and the second data set fails to meet a combined threshold.

The first musical key selected for the first data set is the same as that illustrated in FIG. 3A and ♭FIG. 2A, since the first data set meets the first separate threshold, and so is not discussed further for the sake of clarity. The second musical key selected for the second data set, however, is different. Since the second data set also meets its separate threshold, a harmonious musical key should be selected so that, if presented separately, the tones for the second data set should be harmonious. However, since the combined threshold is not met, the second musical key should be selected such the result is discordant if presented concurrently with tones in the first musical key—that is, the first musical key and the second musical key should be mutually discordant musical keys.

Therefore, the tones illustrated in FIG. 3B for the second musical key are form the tonic chord of the musical key of D major (specifically, the first inversion of the D-major triad, F♯-A-D). When presented separately, this major chord should be perceived as bright and harmonious. However, when presented with the tones of the first musical key, the heptad E-F♯-G-A-C-D-E is formed, which should be perceived as discordant at least due to the dissonance in the half-step interval between the F♯ and G. These tones should be perceived as unpleasant, thus clearly indicating the failure to meet the combined threshold.

In the examples discussed above, harmonious musical keys were used to indicate compliance with a threshold and discordant musical keys were used to indicate failure to comply with a threshold. In some embodiments, different choices of musical keys may be made to indicate compliance versus non-compliance with thresholds. As one non-limiting example, a choice between a harmonious major musical key and a harmonious minor musical key may be indicate compliance with separate thresholds. In such an example, mutually harmonious musical keys or mutually discordant musical keys may still be chosen in either major or minor musical keys, thus allowing compliance with a combined threshold to be indicated.

One non-limiting example may be using a tonic major dyad or a tonic minor dyad in a first musical key (e.g., C-E or C-E♭) to indicate compliance with a first separate threshold, and a major or minor third based on the mediant of the first musical key (e.g., E-F♯ or E♭-G for major thirds; E-G or E♭-G♭ for minor thirds) to indicate compliance with a second separate threshold if a combined threshold is nevertheless met. The combination of these thirds would lead to different harmonious forms of the tonic triad of the first musical key (e.g., the major, minor, diminished, or augmented tonic triad). If the combined threshold was not met, then mutually discordant dyads may be selected.

Further, in the illustrations above, the tones for each data set are illustrated as being presented as a single triad chord, but this should not be seen as limiting. Accordingly, in some embodiments, tones may be presented as dyads, tetrads, or chords with other numbers of concurrent notes. Likewise, in some embodiments, instead of being presented as a single chord, tones in a musical key may be presented in order as a scale, an arpeggiated chord, or as random notes from the musical key in sequence. Further, though the tones for each data set are illustrated above as versions of the tonic C chord for the musical key of C major (or C minor, in the case of FIG. 2B), in some embodiments, chords other than the tonic chord and/or musical keys other than C may be used. In some embodiments, the musical key may change over time according to a standard chord progression (e.g., I-IV-V-V, I-I-IV-V, I-IV-I-V, etc.) to indicate harmonious musical keys, or may transition chaotically between musical keys to indicate discordant musical keys.

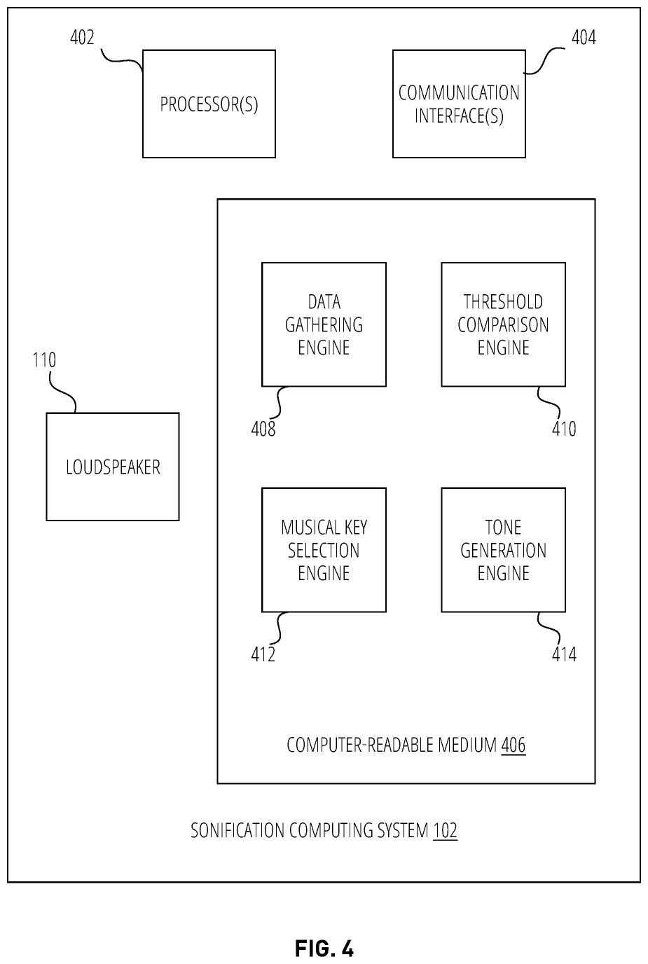

FIG. 4 is a block diagram that illustrates aspects of a non-limiting example embodiment of a sonification computing system according to various aspects of the present disclosure. The sonification computing system 102 is configured to receive data sets from one or more data sources, to compare the data sets to various thresholds, to determine tones to be presented to represent the data sets in various musical keys that reflect whether or not the data sets meet the various thresholds, and to generate presentations of the determined tones.

The illustrated sonification computing system 102 may be implemented by any computing device or collection of computing devices, including but not limited to a desktop computing device, a laptop computing device, a mobile computing device, a server computing device, a computing device of a cloud computing system, and/or combinations thereof.

As shown, the sonification computing system 102 includes one or more processors 402, one or more communication interfaces 404, a loudspeaker 110, and a computer-readable medium 406.

In some embodiments, the processors 402 may include any suitable type of general-purpose computer processor. In some embodiments, the processors 402 may include one or more special-purpose computer processors or AI accelerators optimized for specific computing tasks, including but not limited to graphical processing units (GPUs), vision processing units (VPTs), and tensor processing units (TPUs).

In some embodiments, the communication interfaces 404 include one or more hardware and or software interfaces suitable for providing communication links between components. The communication interfaces 404 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

In some embodiments, the loudspeaker 110 may be any type of device or hardware component capable of generating sound. In some embodiments, the loudspeaker 110 may be an integrated part of a computing device (e.g., an internal speaker on a desktop computing device, a laptop computing device, a mobile computing device, etc.). In some embodiments, the loudspeaker 110 may be connected to a computing device via a wired connection (e.g., an external speaker, a wired headset, etc.) or a wireless connection (e.g., a Bluetooth speaker, etc.).

As shown, the computer-readable medium 406 has stored thereon logic that, in response to execution by the one or more processors 402, cause the sonification computing system 102 to provide a data gathering engine 408, a threshold comparison engine 410, a musical key selection engine 412, and a tone generation engine 414.

In some embodiments, the data gathering engine 408 is configured to gather data sets from one or more data sources. In some embodiments, the threshold comparison engine 410 is configured to compare the gathered data sets to one or more thresholds. In some embodiments, the musical key selection engine 412 is configured to select musical keys for tones that represent the comparisons between the data sets and the thresholds. In some embodiments, the tone generation engine 414 is configured to cause the loudspeaker 110 to generate the tones.

Further description of the configuration of each of these components is provided below.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

As used herein, “engine” refers to logic embodied in hardware or software instructions, which can be written in one or more programming languages, including but not limited to C, C++, C#, COBOL, JAVA™, PHP, Perl, HTML, CSS, JavaScript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a musical key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

Though illustrated as a single computing system, it should be noted that two or more computing devices may operate together to provide the illustrated functionality of the sonification computing system 102. As a non-limiting example, a server computing device may provide the data gathering engine 408, the threshold comparison engine 410, and the musical key selection engine 412, while a mobile computing device may provide the tone generation engine 414 and the loudspeaker 110. As yet another non-limiting example, a first computing device may provide all of the components except for the loudspeaker 110, and the loudspeaker 110 may be provided by a second computing device such as a wired or wireless headset.

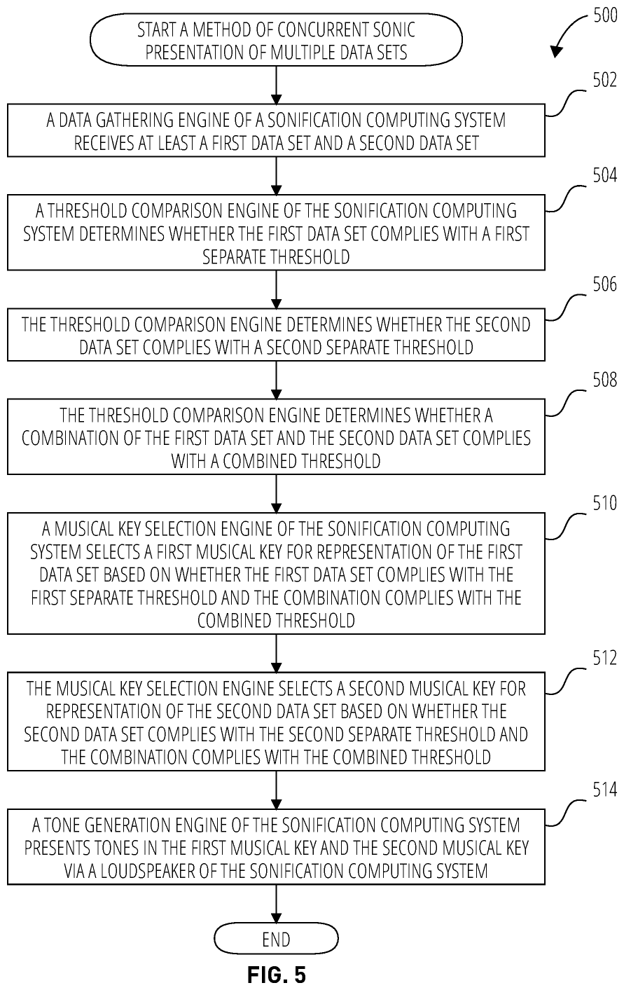

FIG. 5 is a flowchart that illustrates a non-limiting example embodiment of a method of concurrent sonic presentation of multiple data sets according to various aspects of the present disclosure.

From a start block, the method 500 proceeds to block 502, where a data gathering engine 408 of a sonification computing system 102 receives at least a first data set and a second data set. As illustrated in FIG. 1, the sonification computing system 102 receives the data sets from data sources using any suitable technique, including but not limited to wired communication, wireless communication, or the exchange of a removable computer-readable medium. As also illustrated in FIG. 1, the first data set and the second data set may be received from a single data source or may each be received from two or more different data sources. The first data set and the second data set may be any suitable types of data sets, including but not limited to a single value and a series of values (including but not limited to a time series of values). As further discussed above, the first data set and the second data set may represent any type of data, though in some embodiments, the first data set represents the same type of data as the second data set so that the comparison to the combined threshold as described below is meaningful.

At block 504, a threshold comparison engine 410 of the sonification computing system 102 determines whether the first data set complies with a first separate threshold. In some embodiments, the threshold comparison engine 410 may compare a single value of the first data set to a value that represents the first separate threshold to determine whether the value of the first data set is greater than or less than the value that represents the first separate threshold. In some embodiments, the threshold comparison engine 410 may compare one or more values of the first data set to a value that represents the first separate threshold, and may determine that the first data set complies with the first separate threshold based on whether or not the one or more values are equal to the value that represents the first separate threshold.

In some embodiments wherein the first data set is a series of values, the first data set may compare each of the values in the series of values to the value that represents the first separate threshold. In other embodiments wherein the first data set is a series of values, another characteristic of the series of values, including but not limited to a total of the series of values, a mean of the series of values, a maximum or minimum value of the series of values, a size of a range of the series of values, or a standard deviation of the series of values, may be determined and then compared to the value that represents the first separate threshold.

At block 506, the threshold comparison engine 410 determines whether the second data set complies with a second separate threshold. As with the determination at block 504, the determination at block 506 may compare a single value of the second data set to a single value representing the second separate threshold, each value of a series of values of the second data set to a value representing the second separate threshold, or a characteristic of a series of values of the second data set to a value representing the second separate threshold.

In some embodiments, the second separate threshold has a type and a value that matches that of the first separate threshold. In some embodiments, the second separate threshold may have a type that matches that of the first separate threshold but a different value. As a non-limiting example, the first separate threshold and the second separate threshold may both represent occupancy limits, but the values for the first separate threshold and the second separate threshold may be different to represent buildings of different sizes. In some embodiments, the first separate threshold and the second separate threshold may be of different types (e.g., the first separate threshold may represent a maximum value and the second separate threshold may represent a minimum value; the first separate threshold may represent a maximum value and the second separate threshold may represent a maximum mean value, etc.).

At block 508, the threshold comparison engine 410 determines whether a combination of the first data set and the second data set complies with a combined threshold. In some embodiments, the threshold comparison engine 410 combines one or more values from the first data set with one or more values from the second data set to be compared to the combined threshold. In some embodiments, the threshold comparison engine 410 may add a value of the first data set to a value of the second data set. In some embodiments wherein both the first data set and the second data set include series of values, the threshold comparison engine 410 may align the series of values for the first data set and the series of values for the second data set (e.g., by aligning timestamps of time series data, etc.) before adding or otherwise combining corresponding values from the series of values of the first data set and from the series of values of the second data set. In some embodiments, the combined value (or values) may be compared directly to the combined threshold. In some embodiments, another characteristic of a combined series of values (e.g., a total, an average, a maximum value, a minimum value, a range, a standard deviation, etc.) may be compared to the combined threshold.

At block 510, a musical key selection engine 412 of the sonification computing system 102 selects a first musical key for representation of the first data set based on whether the first data set complies with the first separate threshold and the combination complies with the combined threshold, and at block 512, the musical key selection engine 412 selects a second musical key for representation of the second data set based on whether the second data set complies with the second separate threshold and the combination complies with the combined threshold.

In some embodiments, if the first data set complies with the first separate threshold, then the first musical key is a first compliant musical key, and if it does not comply, then the first musical key is a first noncompliant musical key. As illustrated in FIG. 2A and FIG. 2C, the first compliant musical key may be a harmonious musical key and the first noncompliant musical key may be a discordant musical key. Likewise, if the second data set complies with the second separate threshold, then the second musical key is a second compliant musical key (e.g., a harmonious musical key), and if it does not comply, then the second musical key is a second noncompliant musical key (e.g., a discordant musical key).

Further, the musical keys selected for the first musical key and the second musical key are chosen to be mutually harmonious musical keys or mutually discordant musical keys based on whether the first data set and the second data set comply with the combined threshold. For example, if the combined threshold is met then the first musical key and the second musical key are mutually harmonious musical keys (as illustrated in FIG. 3A), whereas if the combined threshold is not met, then the first musical key and the second musical key are mutually discordant musical keys (regardless of whether the first musical key is a harmonious musical key and/or the second musical key is a harmonious musical key) (as illustrated in FIG. 3B).

At block 514, a tone generation engine 414 of the sonification computing system 102 presents tones in the first musical key and the second musical key via a loudspeaker 110 of the sonification computing system 102. In some embodiments, the tones may be pure tones generated by a synthesizer of the tone generation engine 414. In some embodiments, the tones may be synthesized versions of real instruments generated by the tone generation engine 414. In some embodiments, the tones may be sampled sound from real instruments previously recorded by the tone generation engine 414.

In some embodiments, the tones may be presented concurrently (e.g., in a single chord). In some embodiments, the tones may be presented in sequence (e.g., as an arpeggiated chord, as a scale, etc.). In some embodiments, the tones may be concurrently presented in all cases. In some embodiments, the tones may be selectively presented. For example, a user of the sonification computing system 102 may configure the tone generation engine 414 to present the tones for the first data set and the tones for the second data set separately, and then to concurrently present the tones for the first data set and the second data set. In this way, the user may quickly review each of the separate thresholds for compliance before checking the combined threshold for compliance, even on computing devices with limited or no display capability.

The method 500 then proceeds to an end block and terminates.

While illustrative embodiments have been illustrated and described, it will be appreciated that various changes can be made therein without departing from the spirit and scope of the invention. For example, embodiments were described above that included comparisons of a first data set and a second data set to a combined threshold for ease of discussion, but the use of two data sets should not be seen as limiting. In some embodiments, more than two data sets may be combined to be compared to the combined threshold, with all of the musical keys being chosen to be mutually harmonious musical keys or mutually discordant musical keys based on the comparison of the combination to the combined threshold.

As another example, the discussion above was primarily related to presentation of concurrent tones (e.g., dyads, triads, etc.). In some embodiments, scales and arpeggios may be used to represent information from multiple data sources, with separate notes of a scale or arpeggiated chord used to represent different data sets. Easily understood scales, such as a major scale, minor scale, etc. may be used as a base musical key, with compliant data being represented by notes in the base musical key and non-compliant data being represented by notes outside of the base musical key or out of sequence in the scale or arpeggiated chord. The unexpected notes will be easily detectible, thereby indicating the non-compliant data.

As a simple example of this functionality, eight rooms in a single building may be monitored for compliance with occupancy thresholds, and each room may be represented by a note in the C-major scale. If all eight rooms meet their occupancy thresholds, then the notes presented would be the expected notes of the C-major scale (C-D-E-F-G-A-B-C). If any one or more of those rooms did not meet their occupancy threshold, then the system would automatically change the corresponding note, either by a half tone to create a discordant interval between tones (e.g., C-D-E-F-G♭-A-B-C, creating a discordant interval between the F and G♭), by a full tone to create a repeated tone (e.g., C-D-E-F-F-A-B-C), or by any other suitable interval. Using scales or arpeggiated chords in this way allows for the monitoring of large numbers of data sets by simply using longer scales or larger arpeggiated chords.

The use of scales and arpeggios to represent multiple data sets may provide benefits in many different applications, including but not limited to monitoring readings on multiple instruments in a setting such as an aircraft or an automobile, and monitoring vital signs on multiple devices in an operating room. Another non-limiting example of a useful application of this technique is in analyzing a sequence of movements, such as a golf swing. Motion sensors, cameras, or other types of devices may be used to gather information representing a movement executed by a user. The movement may be analyzed by a computing device to compare the sensed movement to various desired characteristics of the movement, and a scale or arpeggio may be presented to represent whether the characteristics of the movement met the desired parameters. For a golf swing, desired characteristics may include a straight leading arm, a consistent swing plane, flatness or uprightness of swing plane, openness of hips at impact, angle of front shoulder at impact, swing speed, swing pace, etc. A scale or arpeggio may be created based on whether each of these characteristics is within a desired range. In some embodiments, the scale/arpeggio and combined threshold functionality may be combined to provide a sonic presentation analyzing multiple characteristics of the movement over time. For example, at multiple different points in a golf swing, multiple different characteristics (e.g., hand and/or wrist position/orientation, shoulder position/orientation, hip position/orientation, head position/orientation, foot position/orientation, speeds of movement, etc.) may be measured and compared to desired characteristics for the given point in the swing (e.g., address, takeaway, backswing, top of the swing, downswing, impact, release, extension, and follow-through). Each characteristic may be considered a data set to be compared to a separate threshold as discussed above. Any combination of characteristics may be used as a combined threshold (including but not limited to hand position/orientation+shoulder position/orientation; shoulder position/orientation+hip position/orientation; etc.), and may be processed as discussed above.

As still another example of various changes that may be made in some embodiments of the present disclosure, the harmonious musical keys and discordant musical keys described above were described with respect to a specific Western classical musical tradition. In some embodiments, harmonious musical keys may be musical keys considered to be expected in a particular musical tradition, while discordant musical keys may be musical keys considered to not be expected in a particular musical tradition, such that the harmonious musical keys can easily be distinguished from discordant musical keys by ear. In some embodiments, instead of using harmonious musical keys and discordant musical keys, the sonification computing system 102 may use musical keys of a first type (e.g., major musical keys) and musical keys of a second type (e.g., minor musical keys) that are also easily distinguished from each other by ear.

### EXAMPLES

Example 1: A method of concurrent sonic presentation of multiple data sets, the method comprising: determining whether a first data set complies with a first separate threshold; determining whether a second data set complies with a second separate threshold; determining whether the first data set and the second data set comply with a combined threshold; selecting a first musical key for representation of the first data set and a second musical key for representation of the second data set based on at least the determinations of whether the first data set complies with the first separate threshold, whether the second data set complies with the second separate threshold, and whether the first data set and the second data set comply with the combined threshold; and presenting tones in the first musical key and the second musical key, wherein the tones are harmonious or discordant based on whether the first data set and the second data set comply with the combined threshold.

Example 2: The method of Example 1, wherein selecting the first musical key for representation of the first data set includes selecting a first compliant musical key in response to determining that the first data set complies with the first separate threshold and selecting a first noncompliant musical key in response to determining that the first data set does not comply with the first separate threshold; and wherein selecting the second musical key for representation of the second data set includes selecting a second compliant musical key in response to determining that the second data set complies with the second separate threshold and selecting a second noncompliant musical key in response to determining that the second data set does not comply with the second separate threshold.

Example 3: The method of Example 2, wherein the first compliant musical key and the second compliant musical key are harmonious musical keys, and wherein the first noncompliant musical key and the second noncompliant musical key are discordant musical keys.

Example 4: The method of Example 3, wherein selecting the first musical key for representation of the first data set and the second musical key for representation of the second data set further includes: selecting mutually harmonious musical keys for the first musical key and the second musical key in response to determining that the first data set and the second data set comply with the combined threshold; and selecting mutually discordant musical keys for the first musical key and the second musical key in response to determining that the first data set and the second data set do not comply with the combined threshold.

Example 5: The method of Example 1, wherein the first data set and the second data set represent building occupancy rates.

Example 6: The method of Example 1, wherein presenting tones in the first musical key and the second musical key includes concurrently presenting the tones in the first musical key and the second musical key.

Example 7: The method of Example 1, wherein presenting tones in the first musical key and the second musical key includes presenting sequential tones in the first musical key and the second musical key.

Example 8: A computing system including a loudspeaker, a processor, and a non-transitory computer-readable medium having computer-executable instructions stored thereon that, in response to execution by the processor, cause the computing system to perform actions for concurrent sonic presentation of multiple data sets, the actions comprising: determining whether a first data set complies with a first separate threshold; determining whether a second data set complies with a second separate threshold; determining whether the first data set and the second data set comply with a combined threshold; selecting a first musical key for representation of the first data set and a second musical key for representation of the second data set based on at least the determinations of whether the first data set complies with the first separate threshold, whether the second data set complies with the second separate threshold, and whether the first data set and the second data set comply with the combined threshold; and presenting, using the loudspeaker, tones in the first musical key and the second musical key, wherein the tones are harmonious or discordant based on whether the first data set and the second data set comply with the combined threshold.

Example 9: The computing system of Example 8, wherein selecting the first musical key for representation of the first data set includes selecting a first compliant musical key in response to determining that the first data set complies with the first separate threshold and selecting a first noncompliant musical key in response to determining that the first data set does not comply with the first separate threshold; and wherein selecting the second musical key for representation of the second data set includes selecting a second compliant musical key in response to determining that the second data set complies with the second separate threshold and selecting a second noncompliant musical key in response to determining that the second data set does not comply with the second separate threshold.

Example 10: The computing system of Example 9, wherein the first compliant musical key and the second compliant musical key are harmonious musical keys, and wherein the first noncompliant musical key and the second noncompliant musical key are discordant musical keys.

Example 11: The computing system of Example 9, wherein selecting the first musical key for representation of the first data set and the second musical key for representation of the second data set further includes: selecting mutually harmonious musical keys for the first musical key and the second musical key in response to determining that the first data set and the second data set comply with the combined threshold; and selecting mutually discordant musical keys for the first musical key and the second musical key in response to determining that the first data set and the second data set do not comply with the combined threshold.

Example 12: The computing system of Example 8, wherein the first data set and the second data set represent building occupancy rates.

Example 13: The computing system of Example 8, wherein presenting tones in the first musical key and the second musical key includes concurrently presenting the tones.

Example 14: The computing system of Example 8, wherein presenting tones in the first musical key and the second musical key includes presenting sequential tones in the first musical key and the second musical key.

Example 15: A non-transitory computer-readable medium having computer-executable instructions stored thereon that, in response to execution by one or more processors of a computing device, cause the computing device to perform actions for concurrent sonic presentation of multiple data sets, the actions comprising: determining whether a first data set complies with a first separate threshold; determining whether a second data set complies with a second separate threshold; determining whether the first data set and the second data set comply with a combined threshold; selecting a first musical key for representation of the first data set and a second musical key for representation of the second data set based on at least the determinations of whether the first data set complies with the first separate threshold, whether the second data set complies with the second separate threshold, and whether the first data set and the second data set comply with the combined threshold; and presenting tones in the first musical key and the second musical key, wherein the tones are harmonious or discordant based on whether the first data set and the second data set comply with the combined threshold.

Example 16: The computer-readable medium of Example 15, wherein selecting the first musical key for representation of the first data set includes selecting a first compliant musical key in response to determining that the first data set complies with the first separate threshold and selecting a first noncompliant musical key in response to determining that the first data set does not comply with the first separate threshold; and wherein selecting the second musical key for representation of the second data set includes selecting a second compliant musical key in response to determining that the second data set complies with the second separate threshold and selecting a second noncompliant musical key in response to determining that the second data set does not comply with the second separate threshold.

Example 17: The computer-readable medium of Example 16, wherein the first compliant musical key and the second compliant musical key are harmonious musical keys, and wherein the first noncompliant musical key and the second noncompliant musical key are discordant musical keys.

Example 18: The computer-readable medium of Example 16, wherein selecting the first musical key for representation of the first data set and the second musical key for representation of the second data set further includes: selecting mutually harmonious musical keys for the first musical key and the second musical key in response to determining that the first data set and the second data set comply with the combined threshold; and selecting mutually discordant musical keys for the first musical key and the second musical key in response to determining that the first data set and the second data set do not comply with the combined threshold.

Example 19: The computer-readable medium of Example 15, wherein the first data set and the second data set represent building occupancy rates.

Example 20: The computer-readable medium of Example 15, wherein presenting tones in the first musical key and the second musical key includes concurrently presenting the tones in the first musical key and the second musical key.

Example 21: The computer-readable medium of Example 15, wherein presenting tones in the first musical key and the second musical key includes presenting sequential tones in the first musical key and the second musical key.

Example 22: A computer-implemented method of arranging and presenting a concurrent sonic representation of multiple data sets, the method comprising: for each data set of a plurality of data sets: determining a threshold for compliance for the data set; selecting a first set of musical tones and a second set of musical tones for the data set, wherein the first set of musical tones sounds harmonious and represents compliance to the threshold and wherein the second set of musical tones sounds discordant and represents non-compliance to the threshold; wherein concurrent presentation of musical tones for multiple data sets sounds harmonious when a combined threshold is met by the multiple data sets and sounds discordant when the combined threshold is not met by the multiple data sets.

Example 23: The computer-implemented method of Example 22, further comprising concurrently presenting musical tones for the plurality of the data sets.

Example 24: The computer-implemented method of Example 22, wherein the data sets of the plurality of data sets represent building occupancy rates.

1. A method of concurrent sonic presentation of multiple data sets, the method comprising:
determining whether a first data set complies with a first separate threshold;
determining whether a second data set complies with a second separate threshold;
determining whether the first data set and the second data set comply with a combined threshold;
selecting a first musical key for representation of the first data set and a second musical key for representation of the second data set based on at least the determinations of whether the first data set complies with the first separate threshold, whether the second data set complies with the second separate threshold, and whether the first data set and the second data set comply with the combined threshold; and
presenting tones in the first musical key and the second musical key, wherein the tones are harmonious or discordant based on whether the first data set and the second data set comply with the combined threshold.

2. The method of claim 1, wherein selecting the first musical key for representation of the first data set includes selecting a first compliant musical key in response to determining that the first data set complies with the first separate threshold and selecting a first noncompliant musical key in response to determining that the first data set does not comply with the first separate threshold; and
wherein selecting the second musical key for representation of the second data set includes selecting a second compliant musical key in response to determining that the second data set complies with the second separate threshold and selecting a second noncompliant musical key in response to determining that the second data set does not comply with the second separate threshold.

3. The method of claim 2, wherein the first compliant musical key and the second compliant musical key are harmonious musical keys, and wherein the first noncompliant musical key and the second noncompliant musical key are discordant musical keys.

4. The method of claim 2, wherein selecting the first musical key for representation of the first data set and the second musical key for representation of the second data set further includes:
selecting mutually harmonious musical keys for the first musical key and the second musical key in response to determining that the first data set and the second data set comply with the combined threshold; and
selecting mutually discordant musical keys for the first musical key and the second musical key in response to determining that the first data set and the second data set do not comply with the combined threshold.

5. The method of claim 1, wherein the first data set and the second data set represent building occupancy rates.

6. The method of claim 1, wherein presenting tones in the first musical key and the second musical key includes concurrently presenting the tones in the first musical key and the second musical key.

7. The method of claim 1, wherein presenting tones in the first musical key and the second musical key includes presenting sequential tones in the first musical key and the second musical key.

8. A computing system including a loudspeaker, a processor, and a non-transitory computer-readable medium having computer-executable instructions stored thereon that, in response to execution by the processor, cause the computing system to perform actions for concurrent sonic presentation of multiple data sets, the actions comprising:
determining whether a first data set complies with a first separate threshold;
determining whether a second data set complies with a second separate threshold;
determining whether the first data set and the second data set comply with a combined threshold;
selecting a first musical key for representation of the first data set and a second musical key for representation of the second data set based on at least the determinations of whether the first data set complies with the first separate threshold, whether the second data set complies with the second separate threshold, and whether the first data set and the second data set comply with the combined threshold; and
presenting, using the loudspeaker, tones in the first musical key and the second musical key, wherein the tones are harmonious or discordant based on whether the first data set and the second data set comply with the combined threshold.

9. The computing system of claim 8, wherein selecting the first musical key for representation of the first data set includes selecting a first compliant musical key in response to determining that the first data set complies with the first separate threshold and selecting a first noncompliant musical key in response to determining that the first data set does not comply with the first separate threshold; and
wherein selecting the second musical key for representation of the second data set includes selecting a second compliant musical key in response to determining that the second data set complies with the second separate threshold and selecting a second noncompliant musical key in response to determining that the second data set does not comply with the second separate threshold.

10. The computing system of claim 9, wherein the first compliant musical key and the second compliant musical key are harmonious musical keys, and wherein the first noncompliant musical key and the second noncompliant musical key are discordant musical keys.

11. The computing system of claim 9, wherein selecting the first musical key for representation of the first data set and the second musical key for representation of the second data set further includes:
selecting mutually harmonious musical keys for the first musical key and the second musical key in response to determining that the first data set and the second data set comply with the combined threshold; and
selecting mutually discordant musical keys for the first musical key and the second musical key in response to determining that the first data set and the second data set do not comply with the combined threshold.

12. The computing system of claim 8, wherein the first data set and the second data set represent building occupancy rates.

13. The computing system of claim 8, wherein presenting tones in the first musical key and the second musical key includes concurrently presenting the tones.

14. The computing system of claim 8, wherein presenting tones in the first musical key and the second musical key includes presenting sequential tones in the first musical key and the second musical key.

15. A non-transitory computer-readable medium having computer-executable instructions stored thereon that, in response to execution by one or more processors of a computing device, cause the computing device to perform actions for concurrent sonic presentation of multiple data sets, the actions comprising:
determining whether a first data set complies with a first separate threshold;
determining whether a second data set complies with a second separate threshold;
determining whether the first data set and the second data set comply with a combined threshold;
selecting a first musical key for representation of the first data set and a second musical key for representation of the second data set based on at least the determinations of whether the first data set complies with the first separate threshold, whether the second data set complies with the second separate threshold, and whether the first data set and the second data set comply with the combined threshold; and
presenting tones in the first musical key and the second musical key, wherein the tones are harmonious or discordant based on whether the first data set and the second data set comply with the combined threshold.

16. The computer-readable medium of claim 15, wherein selecting the first musical key for representation of the first data set includes selecting a first compliant musical key in response to determining that the first data set complies with the first separate threshold and selecting a first noncompliant musical key in response to determining that the first data set does not comply with the first separate threshold; and
wherein selecting the second musical key for representation of the second data set includes selecting a second compliant musical key in response to determining that the second data set complies with the second separate threshold and selecting a second noncompliant musical key in response to determining that the second data set does not comply with the second separate threshold.

17. The computer-readable medium of claim 16, wherein the first compliant musical key and the second compliant musical key are harmonious musical keys, and wherein the first noncompliant musical key and the second noncompliant musical key are discordant musical keys.

18. The computer-readable medium of claim 16, wherein selecting the first musical key for representation of the first data set and the second musical key for representation of the second data set further includes:
selecting mutually harmonious musical keys for the first musical key and the second musical key in response to determining that the first data set and the second data set comply with the combined threshold; and
selecting mutually discordant musical keys for the first musical key and the second musical key in response to determining that the first data set and the second data set do not comply with the combined threshold.

19. The computer-readable medium of claim 15, wherein the first data set and the second data set represent building occupancy rates.

20. The computer-readable medium of claim 15, wherein presenting tones in the first musical key and the second musical key includes concurrently presenting the tones in the first musical key and the second musical key.

21. The computer-readable medium of claim 15, wherein presenting tones in the first musical key and the second musical key includes presenting sequential tones in the first musical key and the second musical key.

22. A computer-implemented method of arranging and presenting a concurrent sonic representation of multiple data sets, the method comprising:
for each data set of a plurality of data sets:
determining a threshold for compliance for the data set;
selecting a first set of musical tones and a second set of musical tones for the data set, wherein the first set of musical tones sounds harmonious and represents compliance to the threshold and wherein the second set of musical tones sounds discordant and represents non-compliance to the threshold;
wherein concurrent presentation of musical tones for multiple data sets sounds harmonious when a combined threshold is met by the multiple data sets and sounds discordant when the combined threshold is not met by the multiple data sets.

23. The computer-implemented method of claim 22, further comprising concurrently presenting musical tones for the plurality of the data sets.

24. The computer-implemented method of claim 22, wherein the data sets of the plurality of data sets represent building occupancy rates.
